(19) United States
(12) Patent Application Publication
(10) Pub. No.: US 2014/0142914 A1
(43) Pub. Date: May 22, 2014

(54) MEANS AND METHODS OF MULTIDIMENSIONAL MODELING IN VIVO SPATIAL IMAGE OF AN MRI CONTRAST AGENT

(71) Applicant: ASPECT IMAGING LTD., Shoham (IL)

(72) Inventor: Uri RAPOPORT, Moshav Ben Shemen (IL)

(21) Appl. No.: 13/939,564

(22) Filed: Jul. 11, 2013

Related U.S. Application Data
(60) Provisional application No. 61/729,353, filed on Nov. 22, 2012.

(51) Int. Cl. G06F 19/12

(52) U.S. Cl. CPC G06F 19/12
USPC 703/11

(57) ABSTRACT

A method of multidimensional modeling a magnetic resonance device (MRD) contrast agent introduced within the body of a patient. The method includes: introducing into the patient body or an organ an effective measure of at least one MRD contrast agent; imaging the MRD contrast agent located at least a portion of a body and providing data defining a multidimensional image; loading or otherwise streaming the MRD image to a multidimensional printer; and multidimensionally modeling the MRD contrast agent.

### FIELD OF THE INVENTION

The present invention is in the field of three-dimensional (3D) modeling. In particular, the present invention is in the field of means and methods of multidimensional modeling in vivo spatial image of an MRI contrast agent.

### BACKGROUND OF THE INVENTION

### 3D Printing

Additive manufacturing or 3D printing is a process of making three dimensional solid objects from a digital model. 3D printing is achieved using additive processes, where an object is created by laying down successive layers of material. 3D printing is considered distinct from traditional machining techniques (subtractive processes) which mostly rely on the removal of material by methods such as cutting and drilling.

3D printing is usually performed by a materials printer using digital technology. Since the start of the twenty-first century there has been a large growth in the sales of these machines, and their price has dropped substantially.

In manufacturing, and most especially of machining, subtractive methods have often come first. In fact, the term subtractive manufacturing is a retronym developed in recent years to distinguish traditional methods from the newer additive manufacturing techniques. Although fabrication has included methods that are essentially “additive” for centuries (such as joining plates, sheets, forgings, and rolled work via riveting, screwing, forge welding, or newer kinds of welding), it did not include the information technology component of model-based definition; and the province of machining (generating exact shapes with high precision) was generally subtractive, from filing and turning through milling and grinding.

Personal manufacturing machines are known as “fabbers or 3D fabbers”

The use of additive manufacturing takes virtual designs from computer aided design (CAD) or animationmodeling software, transforms them into thin, virtual, horizontal cross-sections and then creates successive layers until the model is complete. It is a What You See Is What You Get process where the virtual model and the physical model are almost identical.

An STL file approximates the shape of a part or assembly using triangular facets. Smaller facets produce a higher quality surface. VRML (or WRL) files are often used as input for 3D printing technologies that are able to print in full color.

To perform a print the machine reads in the design and lays down successive layers of liquid, powder, or sheet material, and in this way builds up the model from a series of cross sections. These layers, which correspond to the virtual cross section from the CAD model, are joined together or fused automatically to create the final shape. The primary advantage of additive fabrication is its ability to create almost any shape or geometric feature.

The printer resolution is given in layer thickness and X-Y resolution in dpi, [citation needed] or micrometres. Typical layer thickness is around 100 micrometres (0.1 mm), although some machines such as the Objet Connex series can print layers as thin as 16 micrometres. X-Y resolution is comparable to that of laser printers. The particles (3D dots) are around 50 to 100 micrometres (0.05-0.1 mm) in diameter.

Construction of a model with contemporary methods can take from several hours to several days, depending on the method used and the size and complexity of the model. Additive systems can typically produce models in a few hours, although it can vary widely depending on the type of machine being used and the size and number of models being produced simultaneously.

Traditional techniques like injection molding can be less expensive for manufacturing polymer products in high quantities, but additive fabrication can be faster, more flexible and less expensive when producing relatively small quantities of parts. 3D printers give designers and concept development teams the ability to produce parts and concept models using a desktop size printer.

The native resolution of a printer may be sufficient for some applications; if not, resolution and surface finish can be enhanced by printing an object slightly oversized in standard resolution, then removing material with a higher-resolution subtractive process.

Some additive manufacturing techniques use two materials in the course of constructing parts. The first material is the part material and the second is the support material (to support overhanging features during construction). The support material is later removed by heat or dissolved away with a solvent or water.

A number of competing technologies are available. They differ in the way layers are built to create parts, and the materials that can be used. Some methods use melting or softening material to produce the layers, e.g. selective laser sintering (SLS) and fused deposition modeling (FDM), while others lay liquid materials that are cured with different technologies, e.g. stereolithography (SLA). In the case of laminated object manufacturing (LOM), thin layers are cut to shape and joined together (e.g. paper, polymer, metal). Each method has its advantages and drawbacks, and consequently some companies offer a choice between powder and polymer as the material from which the object emerges. Generally, the main considerations are speed, cost of the printed prototype, cost of the 3D printer, choice and cost of materials and colour capabilities.

Printers which work directly with metals are expensive. However, in some cases inexpensive printers have been used to make a mould, which is then used as to make a metal part.

| Type | Technologies | Base materials |
|---|---|---|
| Extrusion | Fused deposition modeling (FDM) | Thermoplastics |
| | | (e.g. PLA, ABS), |
| | | eutecticmetals, |
| | | edible materials |
| Granular | Direct metal laser sintering | Almost any metal |
| | (DMLS) | alloy |
| | Electron beam melting (EBM) | Titanium alloys |
| | Selective heat sintering (SHS) | Thermoplastic powder |
| | [citation needed] | |
| | Selective laser sintering (SLS) | Thermoplastics, |
| | | metal powders, |
| | | ceramic powders |
| | Powder bed and inkjet head 3d | Plaster |
| | printing, Plaster-based 3D printing | |
| | (PP) | |
| Laminated | Laminated object | Paper, metal foil, |
| | manufacturing (LOM) | plastic film |
| Light | Stereolithography (SLA) | photopolymer |
| polymerised | Digital Light Processing (DLP) | liquid resin |

Fused deposition modeling (FDM) developed in the late 1980s. FDM works using a plastic filament or metal wire which is unwound from a coil and supplies material to an extrusion nozzle which can turn the flow on and off. The nozzle is heated to melt the material and can be moved in both horizontal and vertical directions by a numerically controlled mechanism, directly controlled by a computer-aided manufacturing (CAM) software package. The model or part is produced by extruding small beads of thermoplastic material to form layers as the material hardens immediately after extrusion from the nozzle. Stepper motors or servo motors are typically employed to move the extrusion head.

Various polymers are used, including acrylonitrile butadiene styrene (ABS), polycarbonate (PC), polylactic acid (PLA), PC/ABS, and polyphenylsulfone (PPSU).

Like most granular systems CandyFab fuses parts of the layer, and then moves the working area downwards, and then adds another layer of granules and then repeats the process until the piece has built up.

Another approach is selective fusing of print media in a granular bed. In this variation, the unfused media serves to support overhangs and thin walls in the part being produced, reducing the need for auxiliary temporary supports for the workpiece. Typically a laser is used to sinter the media and form the solid. Examples of this a reselective laser sintering (SLS), using metals as well as polymers (e.g. PA, PA-GF, Rigid GF, PEEK, PS, Alumide, Carbonmide, elastomers), and direct metal laser sintering (DMLS).

Electron beam melting (EBM) is a similar type of additive manufacturing technology for metal parts (e.g. titanium alloys). EBM manufactures parts by melting metal powder layer by layer with an electron beam in a high vacuum. Unlike metal sintering techniques that operate below melting point, the parts are fully dense, void-free, and very strong.

The CandyFab printing system uses heated air and granulated sugar. It can be used to produce food-grade art objects.

Another method consists of an inkjet 3D printing system. The printer creates the model one layer at a time by spreading a layer of powder (plaster, or resins) and inkjet printing a binder in the cross-section of the part. The process is repeated until every layer is printed. This technology allows for the printing of full colour prototypes and allows overhangs, as well as elastomer parts. Bonded powder prints can be further strengthened by wax or thermoset polymer impregnation.

The main technology in which photopolymerization is used to produce a solid part from a liquid is stereolithography (SLA).

In digital light processing (DLP), a vat of liquid polymer is exposed to light from a DLP projector under safelight conditions. The exposed liquid polymer hardens. The build plate then moves down in small increments and the liquid polymer is again exposed to light. The process repeats until the model is built. The liquid polymer is then drained from the vat, leaving the solid model. The EnvisionTec Ultra is an example of a DLP rapid prototyping system.

The Objet PolyJet system uses an inkjet printer to spray photopolymer materials in ultra-thin layers (between 16 and 30 microns) layer by layer onto a build tray until the part is completed. Each photopolymer layer is cured by UV light immediately after it is jetted, producing fully cured models that can be handled and used immediately, without post-curing. The gel-like support material, which is designed to support complicated geometries, is removed by hand and water jetting. Also suitable for elastomers.

Ultra-small features may be made by the 3D microfabrication technique of multiphoton photopolymerization. In this approach, the desired 3D object is traced out in a block of gel by a focused laser. The gel is cured to a solid only in the places where the laser was focused, because of the nonlinear nature of photoexcitation, and then the remaining gel is washed away. Feature sizes of under 100 nm are easily produced, as well as complex structures such as moving and interlocked parts. Yet another approach uses a synthetic resin that is solidified using LEDs.

MRI contrast agents are a group of contrast media used to improve the visibility of internal body structures in MRI. The most commonly used compounds for contrast enhancement are gadolinium-based. MRI contrast agents alter the relaxation times of atoms within body tissues where they are present after oral or intravenous administration. In MRI scanners sections of the body are exposed to a very strong magnetic field, a radiofrequency pulse is applied causing some atoms (including those in contrast agents) to spin and then relax after the pulse stops. This relaxation emits energy which is detected by the scanner and is mathematically converted into an image. The MRI image can be weighted in different ways giving a higher or lower signal.

Most clinically used MRI contrast agents work through shortening the T1 relaxation time of protons located nearby. T1 shortens with an increase in rate of stimulated emission from high energy states (spin anti-aligned with the main field) to low energy states (spin aligned). Thermal vibration of the strongly magnetic metal ions in the contrast agent creates oscillating electromagnetic fields at frequencies corresponding to the energy difference between the spin states (via E=hv), resulting in the requisite stimulation.

### 3D Medical Modeling

A few US patent applications teach means and method for 3D modeling of a patient body. The body is firstly imaged AS IS by imaging means, such as MRI and computerized tomography (CT); and than, after sending processed scanned data to a 3D printer, a 3D medical modeling of the body is provided. The 3D body images obtained in his method are generally suitable for surgical training and more specifically, for modeling integral organs and portions thereof, namely bones (broken bones for orthopedic procedures), pharynx (for emergency medicine practice) etc.

Hence for example, a currently abandoned US patent application No US20060058632 “Method of medical modeling” discloses a method of medical modeling comprising the steps of: identifying a plurality of medical facilities each having at least one MRI diagnostic system therein; providing at least one 3D printer at each of the identified medical facilities; providing a data processing facility; conducting a MRI study at one of the identified medical facilities; transmitting MRI data comprising the MRI study from said one of the identified medical facilities to the processing facility; converting the MRI data from a first format to a second format at the processing facility and thereby providing processed MRI data; transmitting the processed MRI data from the processing facility to a 3D printer located on the premises of said one of the identified medical facilities; and utilizing the 3D printer to prepare a 3D model of the MRI study that was previously conducted at said one of the identified medical facilities. The application also discloses The method of medical modeling comprising the steps of: identifying a plurality of medical facilities each having at least one MRI diagnostic system therein; each of the identified medical facilities being located at a geographical location which is substantially displaced from the geographical location of the remaining identified medical facilities; providing at least one 3D printer at each of the identified medical facilities; providing a data processing facility; conducting a MRI study at one of the identified medical facilities; transmitting MRI data comprising the MRI study from said one of the identified medical facilities to the processing facility; converting the MRI data from the format of the MRI diagnostic system located at said one of the identified medical facilities to the format of a 3D printer located at said one of the medical facilities at the processing facility and thereby providing processed MRI data; transmitting the processed MRI data from the processing facility to the 3D printer located at said one of the identified facilities; and utilizing the 3D printer to prepare a 3D model of the MRI study that was previously conducted at said one of the identified medical facilities.

Much similarly, US patent application No. 20120224755 “Single-Action Three-Dimensional Model Printing Methods MRI contrast agents” discloses a system for printing a 3D physical model from an image data set, comprising: a display component for displaying one or more printing templates; and a single-action data processing component that in response to a single-action selection of a printing template, executes the selected printing template to take the image data set as input, generate a geometric representation for use on a 3D printer. This application also discloses a method for printing a 3D physical model from an image data set, comprising: displaying one or more printing templates; selecting a printing template by a single-action; executing the selected printing template to generate a geometric representation; and sending the generated geometric representation to a 3D printer.

MRI contrast agents are administered by injection into the blood stream or orally, depending on the subject of interest. Oral administration is well suited to G.I. tract scans, while intravascular administration proves more useful for most other scans. A variety of agents of both types enhance scans routinely.

### MRD Contrast Agents

### MRI Contrast Agents

MRI contrast agents can be classified in many ways, including by their: chemical composition; administration route; magnetic properties; effect on the image; metal center's presence and nature; biodistribution and applications, such as (a) Extracellular fluid agents (also known as intravenous contrast agents); (b) Blood pool agents (also known as intravascular contrast agents); (c) Organ specific agents (i.e. Gastrointestinal contrast agents and hepatobiliary contrast agents); (d) Active targeting/cell labeling agents (i.e. tumor-specific agents); (e) Responsive (also known as smart or bioactivated) agents and (f) pH-sensitive agents.

Gadolinium(III) containing MRI contrast agents (often termed simply “gado” or “gad”) are the most commonly used for enhancement of vessels in MR angiography or for brain tumor enhancement associated with the degradation of the blood-brain barrier. For large vessels such as the aorta and its branches, the gadolinium(III) dose can be as low as 0.1 mmol per kg body mass. Higher concentrations are often used for finer vasculature. Gd(III) chelates do not pass the blood-brain barrier because they are hydrophilic. Thus, these are useful in enhancing lesions and tumors where the Gd(III) leaks out. In the rest of the body, the Gd(III) initially remains in the circulation but then distributes into the interstitial space or is eliminated by the kidneys. Gadolinium(III) contrast agents can be categorized into: Extracellular fluid agents: a. Ionic (i.e. Magnevist and Dotarem); b. Neutral i.e. Omniscan, Prohance, Gadavist, OptiMARK); Blood pool agents: a. Albumin-binding; gadolinium complexes (i.e. Ablavar and Gadocoletic acid); b. Polymeric gadolinium complexes (i.e. Gadomelitol and Gadomer 17); and Organ-specific agents (i.e. Primovist™ and Multihance which are used as hepatobiliary agents.

Presently, nine different types of gadolinium-containing contrast agents are available in different territories. In European countries, Gd chelated contrast agents approved by the European Medicines Agency (EMA) include: gadoterate (Dotarem); gadodiamide (Omniscan); gadobenate (MultiHance); gadopentetate (Magnevist, Magnegita, Gado-MRT ratiopharm); gadoteridol (ProHance); gadoversetamide (OptiMARK); gadoxetate (Primovist); gadobutrol (Gadovist).

In the US, Gd-chelated contrast agents approved by the U.S. Food and Drug Administration (FDA) include: gadodiamide (Omniscan); gadobenate (MultiHance); gadopentetate (Magnevist); gadoteridol (ProHance); gadofosveset (Ablavar, formerly Vasovist); gadoversetamide (OptiMARK); gadoxetate (Eovist); and gadobutrol (Gadavist).

### CT Contrast Agents

Radiocontrast agents are a type of medical contrast medium used to improve the visibility of internal bodily structures in X-ray based imaging techniques such as computed tomography (CT) and radiography (commonly known as X-ray imaging). Radiocontrast agents are typically iodine or barium compounds.

Despite being part of radiology, magnetic resonance imaging (MRI) functions through different principles and thus utilizes different contrast agents. These compounds work by altering the magnetic properties of nearby hydrogen nuclei.

Iodine based contrast media are usually classified as ionic or non-ionic. Both types are used most commonly in radiology, due to its relatively harmless interaction with the body and its solubility. It is primarily used to visualize vessels, and changes in tissues on radiography and CT, but can also be used for tests of the urinary tract, uterus and fallopian tubes. It may cause the patient to feel as if he or she has urinated on himself. It also puts a metallic taste in the mouth of the patient.

Modern intravenous contrast agents are typically based on iodine. This may be bound either in an organic (non-ionic) compound or an ionic compound. Ionic agents were developed first and are still in widespread use depending on the requirements but may result in additional complications. Organic agents which covalently bind the iodine have fewer side effects as they do not dissociate into component molecules. Many of the side effects are due to the hyperosmolar solution being injected. i.e. they deliver more iodine atoms per molecule. The more iodine, the more “dense” the X-ray effect.

There are many different molecules. Some examples of organic iodine molecules are iohexol, iodixanol and ioversol. Iodine based contrast media are water soluble and harmless to the body. These contrast agents are sold as clear colorless water solutions, the concentration is usually expressed as mg I/ml. Modern iodinated contrast agents can be used almost anywhere in the body. Most often they are used intravenously, but for various purposes they can also be used intraarterially, intrathecally (as in diskography of the spine) and intraabdominally—just about any body cavity or potential space.

Iodine contrast agents are used for the following: Angiography (arterial investigations); oraphy (venous investigations); VCUG (voiding cystourethrography); HSG (hysterosalpinogram); IVU (intravenous urography) etc.

Ionic contrast media typically, but not always, have higher osmolality and more side-effects. Commonly used iodinated contrast agents

| Compound | Name | Type | Iodine content | Osmolality |
|---|---|---|---|---|
| Ionic | Diatrizoate | Monomer | 300 mgI/ml | 1550 High |
| | (Hypaque 50) | | | |
| Ionic | Metrizoate | Monomer | 370 mgI/ml | 2100 High |
| | (Isopaque 370) | | | |
| Ionic | Ioxaglate | Dimer | 320 mgI/ml | 580 Low |
| | (Hexabrix) | | | |

Non-ionic contrast media have lower osmolality and tend to have fewer side-effects

| | | | Iodine | |
|---|---|---|---|---|
| Compound | Name | Type | content | Osmolality |
| Non-ionic | Iopamidol | Monomer | 370 mgI/ml | 796 Low |
| | (Isovue 370) | | | |
| Non-ionic | Iohexol | Monomer | 350 mgI/ml | 884 Low |
| | (Omnipaque 350) | | | |
| Non-ionic | Ioxilan | Monomer | 350 mgI/ml | 695 Low |
| | (Oxilan 350) | | | |
| Non-ionic | Iopromide | Monomer | 370 mgI/ml | 774 Low |
| | (Ultravist 370) | | | |
| Non-ionic | Iodixanol | Dimer | 320 mgI/ml | 290 Low |
| | (Visipaque 320) | | | |

Barium sulfate is mainly used in the imaging of the digestive system. The substance exists as a water insoluble white powder that is made into a slurry with water and administered directly into the gastrointestinal tract: Barium enema (large bowel investigation) and DCBE (double contrast barium enema); Barium swallow (oesophagael investigation); Barium meal (stomach investigation) and double contrast barium meal; Barium follow through (stomach and small bowel investigation); and CT pneumocolon/virtual colonoscopy

Barium sulfate, an insoluble white powder is typically used for enhancing contrast in the GI tract. Depending on how it is to be administered the compound is mixed with water, thickeners, de-clumping agents, and flavourings to make the contrast agent. As the barium sulfate doesn't dissolve, this type of contrast agent is an opaque white mixture. It is only used in the digestive tract; it is usually swallowed or administered as an enema. After the examination, it leaves the body with the feces.

Both air and barium can be used together (hence the term “double-contrast” barium enema) air can be used as a contrast material because it is less radio-opaque than the tissues it is defining. In the picture it highlights the interior of the colon. An example of a technique using purely air for the contrast medium is an air arthrogram where the injection of air into a joint cavity allows the cartilage covering the ends of the bones to be visualised.

Carbon Dioxide also has a role in angiography. It is low-risk as it is a natural product with no risk of allergic potential. However, it can be used only below the diaphragm as there is a risk of embolism in neurovascular procedures. It must be used carefully to avoid contamination with room air when injected. It is a negative contrast agent in that it displaces blood when injected intravascularly.

An older type of contrast agent, Thorotrast was based on thorium dioxide, but this was abandoned since it turned out to be carcinogenic.

### In Vivo Fluorescence Imaging

in vivo fluorescence imaging uses a sensitive camera to detect fluorescence emission from fluorophores in whole-body living small animals. To overcome the photon attenuation in living tissue, fluorophores with long emission at the near-infrared (NIR) region are generally preferred, including widely used small indocarbocyanine dyes.

Molecules that absorb in the near infrared (NIR) region, 700-1000 nm, can be efficiently used to visualize and investigate in vivo molecular targets because most tissues generate little NIR fluorescence. The most common organic NIR fluorophores are polymethines. Among them, pentamethine and heptamethine cyanines comprising benzoxazole, benzothaizole, indolyl, 2-quinoline or 4-quinoline have been found to be the most useful.

Fluorescence images enable determination of cells types, cell activity and protein activity, but provide little information on the structure of the body or body part under investigation. Combination of in vivo fluorescence imaging with other techniques, such as CAT scans, ultrasound imaging, infrared imaging, X-radiography, Raman spectroscopy, single photon emission computed tomography or microwave imaging will enable synergies between the types of information provided by the different probes, allowing, for example, precise knowledge of the location of cell types and cell activities within organs and structures of the body.

Patent application US 2005/0028482 discloses systems and methods for multi-modal imaging with light and a second form of imaging. Light imaging involves the capture of low intensity light from a light-emitting object. A camera obtains a two-dimensional spatial distribution of the light emitted from the surface of the subject. Software operated by a computer in communication with the camera may then convert two-dimensional spatial distribution data from one or more images into a three-dimensional spatial representation. The second imaging mode may include any imaging technique that compliments light imaging. Examples include MRI and CT. An object handling system moves the object to be imaged between the light imaging system and the second imaging system, and is configured to interface with each system. However, the energy inducing the fluorescence within the animal is supplied from a source external to the animal.

### Imaging Tumor Angiogenesis with Fluorescent Proteins

The green fluorescent protein (GFP) is a protein composed of 238 amino acid residues (26.9 kDa) that exhibits bright green fluorescence when exposed to light in the blue to ultraviolet range.[1] [2] Although many other marine organisms have similar green fluorescent proteins, GFP traditionally refers to the protein first isolated from the jellyfish Aequorea victoria. The GFP from A. victoria has a major excitation peak at a wavelength of 395 nm and a minor one at 475 nm. Its emission peak is at 509 nm, which is in the lower green portion of the visible spectrum. The fluorescence quantum yield (QY) of GFP is 0.79. The GFP from the sea pansy (Renilla reniformis) has a single major excitation peak at 498 nm.

In cell and molecular biology, the GFP gene is frequently used as a reporter of expression.[3] In modified forms it has been used to make biosensors, and many animals have been created that express GFP as a proof-of-concept that a gene can be expressed throughout a given organism. The GFP gene can be introduced into organisms and maintained in their genome through breeding, injection with a viral vector, or cell transformation. To date, the GFP gene has been introduced and expressed in many Bacteria, Yeast and other Fungi, fish (such as zebrafish), plant, fly, and mammalian cells, including human.

The availability of GFP and its derivatives has thoroughly redefined fluorescence microscopy and the way it is used in cell biology and other biological disciplines. While most small fluorescent molecules such as FITC (fluorescein isothiocyanate) are strongly phototoxic when used in live cells, fluorescent proteins such as GFP are usually much less harmful when illuminated in living cells. This has triggered the development of highly automated live-cell fluorescence microscopy systems, which can be used to observe cells over time expressing one or more proteins tagged with fluorescent proteins. For example, GFP had been widely used in labelling the spermatozoa of various organisms for identification purposes as in Drosophila melanogaster, where expression of GFP can be used as a marker for a particular characteristic. GFP can also be expressed in different structures enabling morphological distinction. In such cases, the gene for the production of GFP is spliced into the genome of the organism in the region of the DNA that codes for the target proteins and that is controlled by the same regulatory sequence; that is, the gene's regulatory sequence now controls the production of GFP, in addition to the tagged protein(s). In cells where the gene is expressed, and the tagged proteins are produced, GFP is produced at the same time. Thus, only those cells in which the tagged gene is expressed, or the target proteins are produced, will fluoresce when observed under fluorescence microscopy. Analysis of such time lapse movies has redefined the understanding of many biological processes including protein folding, protein transport, and RNA dynamics, which in the past had been studied using fixed (i.e., dead) material. Obtained data are also used to calibrate mathematical models of intracellular systems and to estimate rates of gene expression.

The Vertico SMI microscope using the SPDM Phymod technology uses the so-called “reversible photobleaching” effect of fluorescent dyes like GFP and its derivatives to localize them as single molecules in an optical resolution of 10 nm. This can also be performed as a co-localization of two GFP derivatives (2CLM).

It was argued that tumor progression and angiogenesis are intimately related. To understand the interrelationship between these two processes, real-time imaging can make a major contribution. In this report, fluorescent protein imaging (FPI) and magnetic resonance imaging (MRI) were utilized to demonstrate the effects of selenium on tumor progression and angiogenesis in an orthotopic model of human colon cancer. GEO (well-differentiated human colon carcinoma) cells transfected with green fluorescent protein (GFP) were implanted orthotopically into the colon of athymic nude mice. Beginning at five days post implantation, whole-body FPI was performed to monitor tumor growth in vivo. Upon successful visualization of tumor growth by FPI, animals were randomly assigned to either a control group or a treatment group. Treatment consisted of daily oral administration of the organoselenium compound, methyl-selenocysteine (MSC; 0.2 mg/day×five weeks). Dynamic contrast-enhanced MRI was performed to examine the change in tumor blood volume following treatment. CD31 immunostaining of tumor sections was also performed to quantify microvessel density (MVD). While T1- and T2-weighted MRI provided adequate contrast and volumetric assessment of GEO tumor growth, GFP imaging allowed for high-throughput visualization of tumor progression in vivo. Selenium treatment resulted in a significant reduction in blood volume and microvessel density of GEO tumors. A significant inhibition of tumor growth was also observed in selenium-treated animals compared to untreated control animals. Together, these results highlight the usefulness of multimodal imaging approaches to demonstrate antitumor and anti-angiogenesis efficacy and the promise of selenium treatment of colon cancer. See Bhattacharya et al., Magnetic resonance and fluorescence-protein imaging of the anti-angiogenic and anti-tumor efficacy of selenium in an orthotopic model of human colon cancer. Anticancer Res. 2011 February; 31(2):387-93.

### Using Isotopes Used in Nuclear Medicine

Common isotopes used in nuclear medicine

| isotope | symbol | Z | T_{1/2} | decay | gamma (keV) | positron (keV) |
|---|---|---|---|---|---|---|
| fluorine-18 | ¹⁸F | 9 | 109.77 m | β⁺ | 511 (193%) | 249.8 (97%) |
| gallium-67 | ⁶⁷Ga | 31 | 3.26 d | ec | 93 (39%), | — |
| | | | | | 185 (21%), | |
| | | | | | 300 (17%) | |
| krypton-81m | ^{81m}Kr | 36 | 13.1 s | IT | 190 (68%) | — |
| rubidium-82 | ⁸²Rb | 37 | 1.27 m | β⁺ | 511 (191%) | 3.379 (95%) |
| nitrogen-13 | ¹³N | 7 | 9.97 m | β⁺ | 511 (200%) | 1190 (100%) |
| technetium-99m | ^{99m}TC | 43 | 6.01 h | IT | 140 (89%) | — |
| indium-111 | ¹¹¹In | 49 | 2.80 d | ec | 171 (90%), | — |
| | | | | | 245 (94%) | |
| iodine-123 | ¹²³I | 53 | 13.3 h | ec | 159 (83%) | — |
| xenon-133 | ¹³³Xe | 54 | 5.24 d | β⁻ | 81 (31%) | 0.364 (99%) |
| thallium-201 | ²⁰¹Tl | 81 | 3.04 d | ec | 69-83* (94%), | — |
| | | | | | 167 (10%) | |
| Therapy: | | | | | | |
| yttrium-90 | ⁹⁰Y | 39 | 2.67 d | β⁻ | — | 2.280 (100%) |
| iodine-131 | ¹³¹I | 53 | 8.02 d | β⁻ | 364 (81%) | 0.807 (100%) |

In the present invention, the term ‘MRD contrast agents’ (or ‘MCAs’) refers in a non-limiting manner to each and all of the MRI, CT and ESR contrast agents and agents for fluorescence emission camera, such as NIR fluorophores, fluorescent proteins and isotopes defined above and to any combination thereof.

It is thus a long felt need to provide 3D modeling of solid, semi-solid, liquid or gas phased processed matter to provide, real-time of time-resolved body images, which are currently not 3D modelable.

### SUMMARY OF THE INVENTION

It is one object of the invention to disclose a method of multidimensional modeling an MRD contrast agent (MCA) introduced within the body of a patient. The method comprises steps as follows: introducing into patient body or an organ thereof an effective measure of at least one MCA; by means of an MRD, imaging the MCA located at least a portion of a body and providing data defining a multidimensional image of the same; loading or otherwise streaming the MRD image to a multidimensional printer; and multidimensionally modeling the MCA.

It is another object of the invention to disclose a the method as defined above, wherein the MRD is selected from a group consisting of CAT scanner, ultrasound imager, infrared imager, X-radiography detecting device, Raman spectroscope, single photon emission computed tomography detector or microwave imager, NMR, MRI, ESR, CT and a combination thereof.

It is another object of the invention to disclose a the method as defined above, wherein the multidimensional modeling is selected from a group consisting of 2D modeling and 3D modeling and wherein the multidimensional printer is a 2D and 3D printer, respectively.

It is another object of the invention to disclose a multidimensional modeling system. The system comprising means for introducing into patient's body or organ thereof an effective measure of at least one MCA; an MRD for imaging the MCA within at least a portion of the body r organ thereof; a readable computer data defining a multidimensional image of the same; at least one multidimensional printer in communication with the data for multidimensionally modeling the MCA.

It is another object of the invention to disclose a the system as defined above, wherein the MRD is selected from a group consisting of CAT scanner, ultrasound imager, infrared imager, X-radiography detecting device, Raman spectroscope, single photon emission computed tomography detector or microwave imager, NMR, MRI, ESR, CT and a combination thereof. It is another object of the invention to disclose a the system as defined above, wherein the multidimensional model is selected from a group consisting of 2D model and 3D model and wherein the multidimensional printer is a 2D and 3D printer, respectively.

It is another object of the invention to disclose a method of a complex multidimensional modeling an MRD contrast agent (MCA). The method comprises steps as follows: introducing into patient's body or an organ thereof an effective measure of at least one MCA; by means of at least one first MRD, imaging at least one first MCA located at least a portion of the body or organ thereof and providing data defining a multidimensional image of the same; by means at least one second MRD, imaging at least one second MCA located at least a portion of the body of organ thereof and providing data defining a multidimensional image of the same; loading or otherwise streaming the least one first MRD image and the least one second MRD image to a multidimensional printer; and multidimensionally modeling the MCA such that a complex multidimensional model of the MCA is provided.

It is another object of the invention to disclose a the method as defined above, wherein the least one first MRD and the least one second MRD are selected from a group consisting of CAT scanner, ultrasound imager, infrared imager, X-radiography detecting device, Raman spectroscope, single photon emission computed tomography detector or microwave imager, NMR, MRI, ESR, CT and a combination thereof.

It is another object of the invention to disclose a the method as defined above, wherein the multidimensional modeling is selected from a group consisting of 2D modeling and 3D modeling and wherein the multidimensional printer is a 2D and 3D printer, respectively.

It is another object of the invention to disclose a complex multidimensional modeling system. The system comprising means for introducing into patient's body or organ thereof an effective measure of at least one first MCA and at least one second MCA; at least one first MRD for imaging at least one first MCA within at least a portion of the body or organ thereof and at least one second MRD for imaging at least one second MCA within at least a portion of the body or organ thereof; a readable computer data defining at least one first multidimensional image and at least one second multidimensional image of the same; a computer processing unit for superimposing or otherwise imbedding the at least one first multidimensional image with at least one second multidimensional image; at least one multidimensional printer in communication with the data for multidimensionally modeling the superimposed or otherwise embedded at least one first MCA and at least one second image.

It is another object of the invention to disclose the system as defined above, wherein the MRD is selected from a group consisting of MRI, ESR, CT and a combination thereof.

It is another object of the invention to disclose a the system as defined above, wherein the multidimensional model is selected from a group consisting of 2D model and 3D model and wherein the multidimensional printer is a 2D and 3D printer, respectively.

It is another object of the invention to disclose a method of multidimensional modeling contrast agent and fluorophores heterogeneous sources. The method comprises steps as follows: introducing into patient's body or an organ thereof an effective measure of at least one first MCA and at least one second MCA; by means of at least one MRD, scanning the at least one first MCA located at least a portion of the body or organ thereof and providing data defining a multidimensional image of the same; by means at least one optical detector, detecting the at least one second MCA located at least a portion of the body of organ thereof and providing data defining spatial emission of the same; loading or otherwise streaming the least one first MRD image and the least one second MRD image to a multidimensional printer; and multidimensionally modeling the MCA such that a complex multidimensional model of the MCA is provided.

It is another object of the invention to disclose a the method as defined above, wherein the least one first MRD and the least one second MRD are selected from a group consisting of CAT scanner, ultrasound imager, infrared imager, X-radiography detecting device, Raman spectroscope, single photon emission computed tomography detector or microwave imager, NMR, MRI, ESR, CT and a combination thereof.

It is another object of the invention to disclose the method as defined above, wherein the multidimensional modeling is selected from a group consisting of 2D modeling and 3D modeling and wherein the multidimensional printer is a 2D and 3D printer, respectively.

It is another object of the invention to disclose the method as defined above, wherein the least one second MRD is a fluorescence emission camera.

It is another object of the invention to disclose the method as defined above, wherein the at least one second MCA is a NIR fluorophore.

It is another object of the invention to disclose a system for multidimensional modeling contrast agent-fluorophores heterogeneous-sources. The system comprising means for introducing into patient's body or an organ thereof an effective measure of at least one first MCA and least one second MCA; at least one MRD, useful for (i) scanning the at least one first MCA located at least a portion of the body or organ thereof, and (ii) providing data defining a multidimensional image of the same; at least one optical detector, useful for (i) detecting at least one second MCA located at least a portion of the body of organ thereof, and (ii) providing data defining spatial emission of the same; a root of communication for loading or otherwise streaming the least one first MRD image and the least one second MRD image to at least one multidimensional printer; and multidimensionally modeling the MCAs such that a complex multidimensional model of the MCAs is provided.

It is another object of the invention to disclose the system as defined above, wherein the least one first MRD and the least one second MRD are selected from a group consisting of CAT scanner, ultrasound imager, infrared imager, X-radiography detecting device, Raman spectroscope, single photon emission computed tomography detector or microwave imager, NMR, MRI, ESR, CT and a combination thereof.

It is another object of the invention to disclose the system as defined above, wherein the multidimensional model is selected from a group consisting of 2D model and 3D model and wherein the multidimensional printer is a 2D and 3D printer, respectively.

It is still another object of the invention to disclose the system as defined above, wherein the least one second MRD is a fluorescence emission camera.

It is another object of the invention to disclose the system as defined above, wherein the one second MCA is a NIR fluorophore.

### BRIEF DESCRIPTION OF THE FIGURES

In order to better understand the invention and its implementation in practice, a plurality of embodiments will now be described, by way of non-limiting example only, with reference to the accompanying drawings, wherein

FIG. 1 presents a colored 3D plastic model of blood circulation system of a humane subjected to an MCA;

FIGS. 2A and 2B present a colored 3D plastic model of red blood capillaries 21 on a white organ 22; and

FIGS. 3A and 3B present a conventional X-ray scan (left) and a colored 3D plastic model of the internal portion of the gastrointestinal tract of a patient according to the present invention (right).

### DETAILED DESCRIPTION OF THE PREFERRED EMBODIMENTS

The following description is provided, alongside all chapters of the present invention, so as to enable any person skilled in the art to make use of the invention and sets forth the best modes contemplated by the inventor of carrying out this invention. Various modifications, however, will remain apparent to those skilled in the art, since the generic principles of the present invention have been defined specifically to provide means and methods of multidimensional modeling in vivo spatial image of an MRD's (e.g. MRI, CT etc.) contrast agent(s).

It is one object of the invention to disclose a method of multidimensional modeling an MRD contrast agent (MCA). The MCAs are selected in a non-limiting manner from commercially available and other, one or more and any mixture thereof, including MRI contrast agents (such as Gadolinium(III) containing MRI contrast agents), agents for fluorescence emission camera (such as NIR fluorophores), fluorescent proteins and isotopes as defined above in the Background section.

According to an embodiment of the invention, a method of multidimensional modeling an MRD's MCA comprises steps as follows: introducing into patient body or an organ thereof an effective measure of at least one MCA; by means of an MRD, imaging the MCA located at least a portion of a body and providing data defining a multidimensional image of the same; loading or otherwise streaming the MRD image to a multidimensional printer; and multidimensionally modeling the MCA.

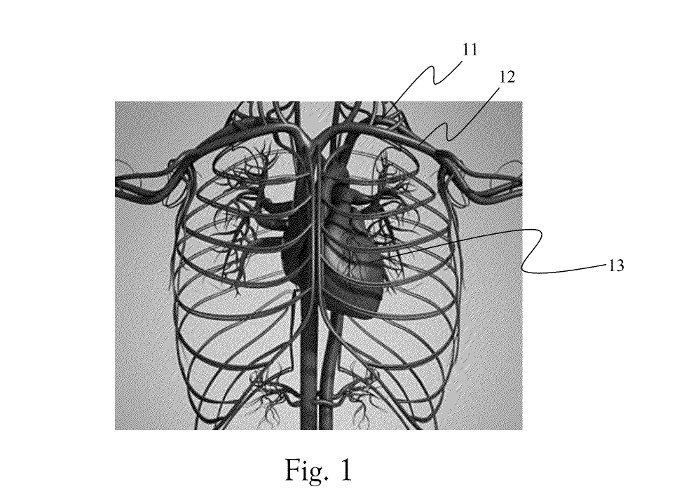

Reference is now made to FIG. 1, presenting a colored 3D plastic model of blood circulation system of a humane subjected to an MCA. An MRI image was processed in a manner that arteries 3D printing (and oxidized portions of the heart) (11) was colored red and veins (and deoxidized portions of the heart) (12) printed in blue. The 3D image of FIG. 1 is printable in the following method comprising step of (a) inflowing, by means of a peripheral IV line an effective measure of e.g., an MRI contrast agent; (b) by means of an MRD, here—MRI, scanning and imaging the MCA at the upper portion of the patient and providing data defining a multidimensional image of the same; (c) streaming the MRI image data to a multidimensional printer; and then (d) multidimensionally modeling the MCA by light polymerizing red and blue photopolymers in an SLA technique by means of a commercially available 3D printer. Similar results are obtainable using two different MCAs and/or two different MRDs, such as MRI and CT.

According to yet another embodiment of the invention, a complex multidimensional modeling system is disclosed. The system comprises medically applicable means for introducing into patient's body or organ thereof an effective measure of at least one first MCA (MRI agent as defined above) and at least one second MCA (CT agent as defined above); at least one first MRD, here an MRI, such as commercially available M2™ by ASPECT IMAGING LTD (US), see currently available link: http://www.aspectimaging.com/products/) for imaging at least one first MCA within at least a portion of the body or organ thereof and at least one second MRD (CT, such as LightSpeed* VCT Xte by GE) for imaging at least one second MCA within at least a portion of the body or organ thereof; a readable computer data defining at least one first multidimensional image and at least one second multidimensional image of the same; a computer processing unit for superimposing or otherwise imbedding the at least one first multidimensional image with at least one second multidimensional image; at least one multidimensional printer (such as commercially available Easy3D model ltd) in communication with the data for multidimensionally modeling the superimposed or otherwise embedded at least one first MCA and at least one second image.

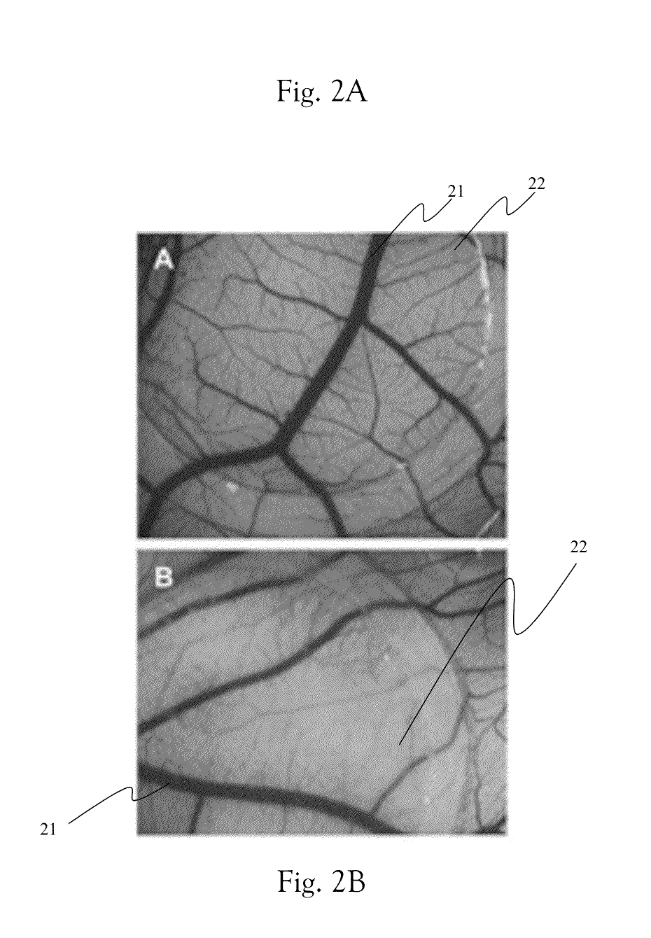

Reference is now made to FIG. 2A and FIG. 2B, presenting a colored 3D plastic model of red blood capillaries 21 on a white organ 22. The complex multidimensional modeling is performable as follows: (1) injecting an MCA, scanning and imaging the MCA when it flows in patient's arteries in a predefined spatial location within the patient by means of a first MRI; (2) scanning and imaging the same spatial location within the patient by means of a first MRI (scanning the organ in a conventional procedure, NOT the MCA); (3) superimposing first 3D image on second 3D image; and (4) 3D printing the superimposed MCA/non MCA images.

Another embodiment of the invention is a system for multidimensional modeling contrast agent-fluorophores heterogeneous-sources. The system comprises, inter alia, means for introducing into patient's body or an organ thereof effective measure of at least one first MCA such as swallowable Barium-containing agent or injectable Gd^{III}-containing agent, and least one second MCA, such as NIR fluorophores and at least one first MRD, such as MRI or CT, useful for (i) scanning the at least one first MCA located at least a portion of the body or organ thereof, and (ii) providing data defining a multidimensional image of the same; at least one optical detector, useful for (i) detecting at least one second MCA, such as commercially available ORCA-R2 fluorescence imaging CCD camera by Hamamatsu Corporation (NJ) located at least a portion of the body of organ thereof, and (ii) providing data defining spatial emission of the same; a root of communication for loading or otherwise streaming the least one first MRD image and the least one second MRD image to at least one multidimensional printer; and multidimensionally modeling the MCAs such that a complex multidimensional model of the MCAs is provided.

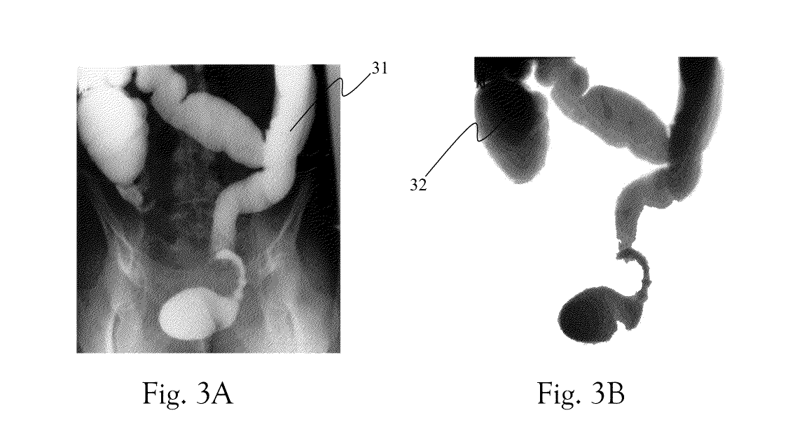

Reference is now made to FIG. 3A and FIG. 3B presenting a conventional X-ray scan (left) and a colored 3D plastic model of the internal portion of the gastrointestinal tract of a patient according to the present invention (right). FIG. 3A shows a 2D image with a presentation of GI track 31, whereas FIG. 3B shows a 3D model which presents a 3D image of the same (32). Here, the inventive system and method thereof shows 3D plastic model of a cavity and not the organ enveloping the same.

I claim:

1. A method of multidimensional modeling an MRD contrast agent (MCA) introduced within the body of a patient, the method comprises steps as follows:
a. introducing into patient body or an organ thereof an effective measure of at least one MCA;
b. by means of an MRD, imaging said MCA located at least a portion of a body and providing data defining a multidimensional image of the same;
c. loading or otherwise streaming said MRD image to a multidimensional printer; and
d. multidimensionally modeling said MCA.

2. The method of claim 1, wherein said MRD is selected from a group consisting of CAT scanner, ultrasound imager, infrared imager, X-radiography detecting device, Raman spectroscope, single photon emission computed tomography detector or microwave imager, NMR, MRI, ESR, CT and a combination thereof.

3. The method of claim 1, wherein said multidimensional modeling is selected from a group consisting of 2D modeling and 3D modeling and wherein said multidimensional printer is a 2D and 3D printer, respectively.

4. A multidimensional modeling system comprising:
a. means for introducing into patient's body or organ thereof an effective measure of at least one MCA;
b. an MRD for imaging said MCA within at least a portion of said body r organ thereof;
c. a readable computer data defining a multidimensional image of the same;
d. at least one multidimensional printer in communication with said data for multidimensionally modeling said MCA.

5. The multidimensional modeling system of claim 4, wherein said MRD is selected from a group consisting of CAT scanner, ultrasound imager, infrared imager, X-radiography detecting device, Raman spectroscope, single photon emission computed tomography detector or microwave imager, NMR, MRI, ESR, CT and a combination thereof.

6. The multidimensional modeling system of claim 4, wherein said multidimensional model is selected from a group consisting of 2D model and 3D model and wherein said multidimensional printer is a 2D and 3D printer, respectively.

7. A method of a complex multidimensional modeling an MRD contrast agent (MCA) introduced within the body of a patient, the method comprises steps as follows:
a. introducing into patient's body or an organ thereof an effective measure of at least one MCA;
b. by means of at least one first MRD, imaging at least one first MCA located at least a portion of said body or organ thereof and providing data defining a multidimensional image of the same;
c. by means at least one second MRD, imaging at least one second MCA located at least a portion of said body of organ thereof and providing data defining a multidimensional image of the same;
d. loading or otherwise streaming said least one first MRD image and said least one second MRD image to a multidimensional printer; and
e. multidimensionally modeling said MCA such that a complex multidimensional model of said MCA is provided.

8. The method of claim 7, wherein said least one first MRD and said least one second MRD are selected from a group consisting of CAT scanner, ultrasound imager, infrared imager, X-radiography detecting device, Raman spectroscope, single photon emission computed tomography detector or microwave imager, NMR, MRI, ESR, CT and a combination thereof.

9. The method of claim 7, wherein said multidimensional modeling is selected from a group consisting of 2D modeling and 3D modeling and wherein said multidimensional printer is a 2D and 3D printer, respectively.

10. A complex multidimensional modeling system comprising:
a. means for introducing into patient's body or organ thereof an effective measure of at least one first MCA and at least one second MCA;
b. at least one first MRD for imaging at least one first MCA within at least a portion of said body or organ thereof and at least one second MRD for imaging at least one second MCA within at least a portion of said body or organ thereof;
c. a readable computer data defining at least one first multidimensional image and at least one second multidimensional image of the same;
d. a computer processing unit for superimposing or otherwise imbedding said at least one first multidimensional image with at least one second multidimensional image;
e. at least one multidimensional printer in communication with said data for multidimensionally modeling said superimposed or otherwise embedded at least one first MCA and at least one second image.

11. The multidimensional modeling system of claim 4, wherein said MRD is selected from a group consisting of MRI, ESR, CT and a combination thereof.

12. The multidimensional modeling system of claim 4, wherein said multidimensional model is selected from a group consisting of 2D model and 3D model and wherein said multidimensional printer is a 2D and 3D printer, respectively.

13. A method of multidimensional modeling contrast agent and fluorophores heterogeneous sources introduced within the body of a patient, the method comprises steps as follows:
a. introducing into patient's body or an organ thereof an effective measure of at least one first MCA and at least one second MCA;
b. by means of at least one MRD, scanning said at least one first MCA located at least a portion of said body or organ thereof and providing data defining a multidimensional image of the same;
c. by means at least one optical detector, detecting said at least one second MCA located at least a portion of said body of organ thereof and providing data defining spatial emission of the same;
d. loading or otherwise streaming said least one first MRD image and said least one second MRD image to a multidimensional printer; and
e. multidimensionally modeling said MCA such that a complex multidimensional model of said MCA is provided.

14. The method of claim 13, wherein said least one first MRD and said least one second MRD are selected from a group consisting of CAT scanner, ultrasound imager, infrared imager, X-radiography detecting device, Raman spectroscope, single photon emission computed tomography detector or microwave imager, NMR, MRI, ESR, CT and a combination thereof.

15. The method of claim 13, wherein said multidimensional modeling is selected from a group consisting of 2D modeling and 3D modeling and wherein said multidimensional printer is a 2D and 3D printer, respectively.

16. The method of claim 13, wherein said least one second MRD is a fluorescence emission camera.

17. The method of claim 13, wherein said one second MCA is a NIR fluorophore.

18. A system for multidimensional modeling contrast agent-fluorophores heterogeneous-sources, the system comprising
a. means for introducing into patient's body or an organ thereof an effective measure of at least one first MCA and least one second MCA;
b. at least one MRD, useful for (i) scanning said at least one first MCA located at least a portion of said body or organ thereof, and (ii) providing data defining a multidimensional image of the same;
c. at least one optical detector, useful for (i) detecting at least one second MCA located at least a portion of said body of organ thereof, and (ii) providing data defining spatial emission of the same;
d. a root of communication for loading or otherwise streaming said least one first MRD image and said least one second MRD image to at least one multidimensional printer; and
e. multidimensionally modeling said MCAs such that a complex multidimensional model of said MCAs is provided.

19. The system of claim 18, wherein said least one first MRD and said least one second MRD are selected from a group consisting of CAT scanner, ultrasound imager, infrared imager, X-radiography detecting device, Raman spectroscope, single photon emission computed tomography detector or microwave imager, NMR, MRI, ESR, CT and a combination thereof.

20. The system of claim 18, wherein said multidimensional model is selected from a group consisting of 2D model and 3D model and wherein said multidimensional printer is a 2D and 3D printer, respectively.

21. The system of claim 18, wherein said least one second MRD is a fluorescence emission camera.

22. The system of claim 18, wherein said one second MCA is a NIR fluorophore.
